(19) United States
(12) Patent Application Publication
(10) Pub. No.: US 2023/0251119 A1
(43) Pub. Date: Aug. 10, 2023

(54) METHOD AND DEVICE FOR MEASURING A FLUX OF A HEAVY OIL-MISCIBLE PHASE FLUID

(71) Applicant: Chengdu Sea Pioneers Technology Co., Ltd., Chengdu (CN)

(72) Inventors: Jige Chen, Chengdu (CN); Bin Xu, Chengdu (CN); Chao Luo, Chengdu (CN)

(21) Appl. No.: 18/098,155

(22) Filed: Jan. 18, 2023

(30) Foreign Application Priority Data
Jan. 21, 2022 (CN) 202210073115.8

(51) Int. Cl. G01F 1/7086; G01F 1/74; G01F 1/661; F17D 3/18

(52) U.S. Cl. CPC G01F 1/7086; F17D 3/18; G01F 1/74; G01F 1/661

(57) ABSTRACT

Disclosed are a method and a device for measuring a flux of a heavy oil-miscible phase fluid, the method including: flowing of the heavy oil-miscible phase fluid out of an oil and gas well through the pipeline, with the heavy oil-miscible phase fluid including at least two fluid media; measuring a total flux of throttling differential pressure of the heavy oil-miscible phase fluid flowing through the streamlined spindle; carrying out a measurement with a light quantum of at least four levels on the heavy oil-miscible phase fluid by the phase separator with light quantum of multi levels, such that a linear mass of each of the at least two fluid media is obtained; and obtaining a flux of each of the at least two fluid media from the total flux of throttling differential pressure and the linear mass of each of the at least two fluid media.

### CROSS-REFERENCE TO RELATED APPLICATION

This application claims the priority and benefit of Chinese patent application serial no. 202210073115.8, filed on Jan. 21, 2022. The entirety of Chinese patent application serial no. 202210073115.8 is hereby incorporated by reference herein and made a part of this specification.

### TECHNICAL FIELD

The present disclosure relates to the technical field of measurement of industrial miscible phase fluid, and in particular, to a method and device for measuring a flux of a heavy oil-miscible phase fluid.

### BACKGROUND

A heavy oil is scientifically defined as a crude oil having a viscosity smaller than 50 mPa·s or larger than 100 mPa·s after degassing under the condition of oil reservoir. The genesis of the heavy oil is very complex. The biggest difference between the heavy oil and an ordinary crude oil is a biodegradation degree. The higher the biodegradation degree is, the more easily the heavy oil is generated.

Commonly used metering methods for single well of heavy oil are separation metering method and tipping-bucket type oil metering method. The separation metering method generally uses a traditional test separator to separate an oil-gas-water three-phase or the gas-water two-phase, and then make measurement on the heavy oil separately. The tipping-bucket type oil metering method is a mechanical method using equipment with movable parts.

However, due to the characteristics of the heavy oil, a separator has a poor separation effect on the heavy oil. The residual gas in the water body after separation will cause a larger error for measuring flux with a water phase flowmeter or a volumetric flowmeter. Moreover, oil and water in the water phase of the heavy oil are not easy to separate, and it is difficult to completely separate three phases, that is, oil, gas, and water, from each other. Further, it is also a challenge to carry out a gas-water two-phase separation and determine the water content in the water phase. Therefore, an offline sampling and analysis method is generally used to determine the water content in the heavy oil, but this cannot realize an online real-time measurement on water content. In contrast, the tipping-bucket type oil metering method has larger metering error, poor effect and high failure rate for a heavy oil with higher viscosity. In addition, offline sampling and analysis method is required to determine the water content in the heavy oil to calculate flux of the oil and water, which fails to truly realize the online real-time measurement of the water content and the online real-time measurement of oil, gas and water. Therefore, neither the separation metering method nor the tipping-bucket type oil metering method can meet the requirements of online measurement on flux of individual fluid media in the heavy oil-miscible phase fluid.

### SUMMARY

A method and device for measuring a flux of a heavy oil-miscible phase fluid in a large diameter pipeline are disclosed, in order to realize an online measurement on flux of individual fluid media in a heavy oil-miscible phase fluid.

In one aspect of the present disclosure, a method for measuring a flux of a heavy oil-miscible phase fluid in a large diameter pipeline is disclosed, comprising:
flowing of the heavy oil-miscible phase fluid out of an oil and gas well through the pipeline, with the heavy oil-miscible phase fluid including at least two fluid media;
measuring a total flux of throttling differential pressure of the heavy oil-miscible phase fluid flowing through the streamlined spindle;
carrying out a measurement with a light quantum of at least four levels on the heavy oil-miscible phase fluid by a phase separator with light quantum of multi levels, such that a linear mass of each of the at least two fluid media is obtained; and
obtaining a flux of each of the at least two fluid media from the total flux of throttling differential pressure and the linear mass of each of the at least two fluid media.

Optionally, a step of measuring a total flux of throttling differential pressure of the heavy oil-miscible phase fluid flowing through the streamlined spindle comprises:
measuring a temperature of the heavy oil-miscible phase fluid flowing through the streamlined spindle;
obtaining a throttling density, a throttling differential pressure, and throttling parameters of the streamlined spindle, with the throttling differential pressure being a differential pressure between a pressure tap of an upstream inlet and an equivalent throat diameter of a throttler of the streamlined spindle, and the throttling density being a mixed density of the heavy oil-miscible phase fluid at the pressure tap of the equivalent throat diameter of the throttler; and
calculating the total flux of throttling differential pressure from the temperature, the throttling parameters, the throttling density and a preset calculation equation of flux of throttling differential pressure.

Optionally, a step of calculating the total flux of throttling differential pressure from the temperature, the throttling parameters, the throttling density and a preset calculation equation of flux of throttling differential pressure comprises:
obtaining a dynamic viscosity of heavy oil from the temperature and a preset prediction equation of dynamic viscosity of heavy oil;
obtaining an inner diameter of the pipeline;
determining a first relationship between a Reynolds number and the total flux of throttling differential pressure from a preset calculation equation of Reynolds number, the dynamic viscosity of heavy oil and the inner diameter;
determining a second relationship between the Reynolds number and a discharge coefficient from a preset calculation equation of discharge coefficient, with the discharge coefficient being a ratio of an actual flux to a theoretical flux of the heavy oil-miscible phase fluid;
verifying, whether the second relationship is correct, from the preset calculation equation of flux of throttling differential pressure, the throttling parameters, the throttling differential pressure and the throttling density; and
carrying out an iterative calculation according to Newton’s method based on the preset calculation equation of flux of throttling differential pressure, if the second relationship is correct.

Optionally, the phase separator with light quantum of multi levels is a phase separator with light quantum of four levels,

a step of carrying out a measurement with a light quantum of at least four levels on the heavy oil-miscible phase fluid by the phase separator with light quantum of multi levels, such that a linear mass of each of the at least two fluid media is obtained comprises:
emitting a light quantum of first level, a light quantum of second level, a light quantum of third level and a light quantum of fourth level through the phase separator with light quantum of multi levels, with energy of the light quantum of first level being 31 keV, energy of the light quantum of second level being 81 keV, energy of the light quantum of third level being 160 keV, and energy of the light quantum of fourth level being 356 keV;
detecting a measured transmission quantity of the light quantum of four levels for each of the at least two fluid media;
obtaining a ratio between medium-free transmission quantities of the light quantum of four levels according to a characteristic of a light quantum source, wherein the medium-free transmission quantity is a transmission quantity in an empty and medium-free pipeline;
obtaining a linear mass absorption coefficient of the light quantum of first level, the light quantum of second level and the light quantum of third level for each of the at least fluid media, and Compton scattering constant of the light quantum of fourth level; and
calculating the linear mass of each of the at least two fluid media from the measured transmission quantity, the ratio between medium-free transmission quantities, the linear mass absorption coefficient and the Compton scattering constant.

Optionally, a step of obtaining a ratio between medium-free transmission quantities of the light quantum of four levels according to a characteristic of a light quantum source comprises:

defining the medium-free transmission quantity of the light quantum of first level as N_{0,1}, a ratio of the medium-free transmission quantity of the light quantum of second level N_{0,2} to N_{0,1} as f₂, a ratio of the medium-free transmission quantity of the light quantum of third level N_{0,3} to N_{0,1} as f₃, and a ratio of the medium-free transmission quantity of the light quantum of fourth level N_{0,4} to N_{0,1} as f₄ according to the characteristic of a light quantum source.

Optionally, a step of calculating the linear mass of each of the at least two fluid media from the measured transmission quantity, the ratio between medium-free transmission quantities, the linear mass absorption coefficient and the Compton scattering constant comprises:
controlling the phase separator to emit the light quantum of first level, the light quantum of second level, the light quantum of third level and the light quantum of fourth level in a pipeline filled with a single fluid medium;
detecting a single-fluid-medium transmission quantity of the light quantum of first level N_{x,1}, a single-fluid-medium transmission quantity of the light quantum of second level N_{x,2}, a single-fluid-medium transmission quantity of the light quantum of third level N_{x,3}, and a single-fluid-medium transmission quantity of the light quantum of fourth level N_{x,4};
calculating a single-fluid-medium linear mass absorption coefficient of the light quantum of first level α_{x,1} from the medium-free transmission quantity of the light quantum of first level N_{0,1} and a single-fluid-medium photoelectric absorption equation of the light quantum of first level;
calculating a single-fluid-medium linear mass absorption coefficient of the light quantum of second level α_{x,2} from the medium-free transmission quantity of the light quantum of second level N_{0,2} and a single-fluid-medium photoelectric absorption equation of the light quantum of second level;
calculating a single-fluid-medium linear mass absorption coefficient of the light quantum of third level α_{x,3} from the medium-free transmission quantity of the light quantum of third level N_{0,3} and a single-fluid-medium photoelectric absorption equation of the light quantum of third level; and
obtaining a Compton scattering constant K₂ from a Compton scattering characteristic of the light quantum of fourth level.

Optionally, a step of calculating a single-fluid-medium linear mass absorption coefficient of the light quantum of first level α_{x,1} from the medium-free transmission quantity of the light quantum of first level N_{0,1} and a single-fluid-medium photoelectric absorption equation of the light quantum of first level comprises:

transforming a photoelectric absorption total equation of the light quantum of first level for each of the at least two fluid media into a single-fluid-medium photoelectric absorption equation

$$ln \left(\frac{{\text{N}}_{\text{o,1}}}{{\text{N}}_{\text{x,1}}}\right) = {\text{α}}_{\text{x,1}} {\text{Q}}_{\text{x}} ; \text{and}$$

introducing the medium-free transmission quantity N_{0,1} and the single-fluid-medium transmission quantity N_{x,1} into the photoelectric absorption total equation of the light quantum of first level for each of the at least two fluid media, to obtain the single-fluid-medium linear mass absorption coefficient of the light quantum of first level

$${\text{α}}_{\text{x,1}} = \frac{ln \left(\frac{{\text{N}}_{\text{0,1}}}{{\text{N}}_{\text{x,1}}}\right)}{{\text{Q}}_{\text{x}}}$$

Optionally, a step of calculating the linear mass of each of the at least two fluid media from the measured transmission quantity, the ratio between medium-free transmission quantities, the linear mass absorption coefficient and the Compton scattering constant comprises:

introducing the measured transmission quantity, the ratio between medium-free transmission quantities, the linear mass absorption coefficient and the Compton scattering constant into the photoelectric absorption total equation of the light quantum of first level for each of the at least two fluid media, a photoelectric absorption total equation of the light quantum of second level for each of the at least two fluid media, a photoelectric absorption total equation of the light quantum of third level for each of the at least two fluid media and the Compton absorption equation of the light quantum of fourth level, respectively, to calculate a linear mass of each of the at least two fluid media Qₓ.

Optionally, a step of obtaining a flux of each of the at least two fluid media from the total flux of throttling differential pressure and the linear mass of each of the at least two fluid media comprises:
dividing the linear mass of each of the at least two fluid media by a linear mass sum of all the at least two fluid media, to obtain a mass fraction of each of the at least two fluid media;
multiplying the mass fraction of each of the at least two fluid media by the total flux of throttling differential pressure, to obtain the flux for each of the at least two fluid media.

In the second aspect, a device for measuring a flux of a heavy oil-miscible phase fluid in a large diameter pipeline is disclosed, wherein the device is installed on the pipeline, the device comprising:
a streamlined spindle and a phase separator with light quantum of multi levels, wherein a heavy oil-miscible phase fluid flows out of an oil and gas well through the pipeline;
wherein the device is configured to carry out the method for measuring a flux of a heavy oil-miscible phase fluid in a large diameter pipeline according to the first aspect, to obtain the flux for each of the at least two fluid media in the heavy oil-miscible phase fluid.

To sum up, the following beneficial technical effects are realized by the present disclosure:

Since the device for measuring a flux of a heavy oil-miscible phase fluid in a large diameter pipeline is installed on the pipeline, the heavy oil-miscible phase fluid flows out of the oil and gas well, the total flux of throttling differential pressure of the heavy oil-miscible phase fluid in the streamlined spindle is measured, and then a measurement with a light quantum of at least four levels is carried out on the heavy oil-miscible phase fluid by the phase separator with light quantum of multi levels, such that a linear mass of each of the at least two fluid media is obtained. A flux of each of the at least two fluid media is obtained from the total flux of throttling differential pressure and the linear mass of each of the at least two fluid media. The flux for each of the at least two fluid media can be measured without sampling and separation test on the heavy oil-miscible phase fluid, thus realizing online measurement.

### BRIEF DESCRIPTION OF THE DRAWINGS

FIG. 1 is a flow diagram of the method for measuring a flux of a heavy oil-miscible phase fluid in a large diameter pipeline of the present application.

FIG. 2 is a structural diagram of the device for measuring a flux of a heavy oil-miscible phase fluid in a large diameter pipeline of the present application.

FIG. 3 is a flow diagram of a step of measuring a total flux of throttling differential pressure.

FIG. 4 is flow diagram of a step of calculating the linear mass of each of the at least two fluid media.

### DESCRIPTION OF THE EMBODIMENTS

In order to make the purpose, technical solution and advantages of the present application more clear, the application is further described in detail below through the drawings and embodiments. It should be understood that the specific embodiments described here are only used to explain the application, not to limit the application.

A method for measuring a flux of a heavy oil-miscible phase fluid in a large diameter pipeline is disclosed.

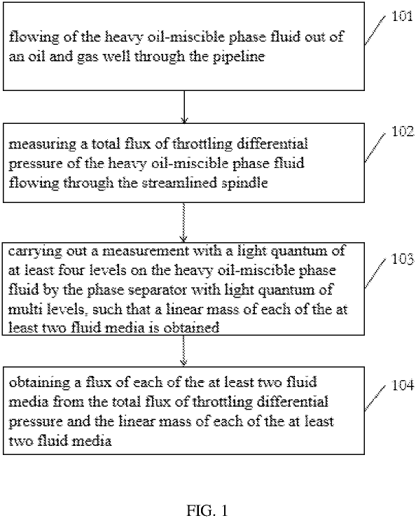

Referring to FIG. 1, the method includes:

101, flowing of the heavy oil-miscible phase fluid out of an oil and gas well through the pipeline.

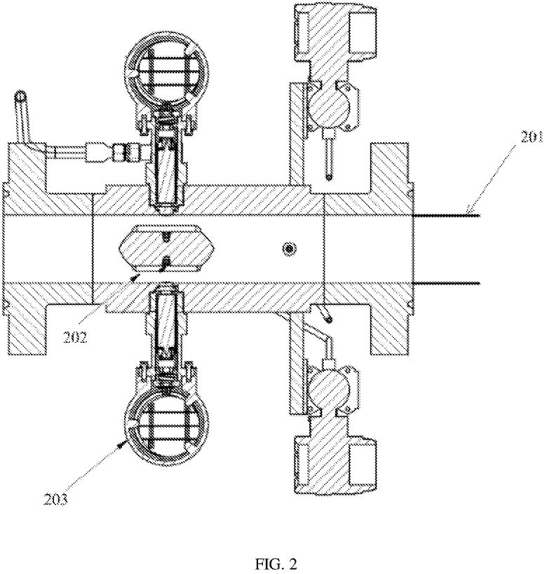

The device for measuring a flux of a heavy oil-miscible phase fluid in a large diameter pipeline is shown in FIG. 2 and installed on the pipeline 201. During the oil exploitation, after completion of the oil and gas well, the heavy oil-miscible fluid flows out of the oil and gas well through the pipeline 201. The device for measuring a flux of a heavy oil-miscible phase fluid in a large diameter pipeline includes a streamlined spindle 202 and a phase separator with light quantum of multi levels 203. The heavy oil-miscible fluid includes at least two fluid media, which can be oil, gas and water.

102, measuring a total flux of throttling differential pressure of the heavy oil-miscible phase fluid flowing through the streamlined spindle.

The streamlined spindle 202 is arranged in the middle of the device for measuring a flux of a heavy oil-miscible phase fluid in a large diameter pipeline, such that a throttling structure is formed. When the heavy oil-miscible fluid passes through the throttling structure, the total flux of throttling differential pressure can be obtained by measuring multiple parameters.

103, carrying out a measurement with a light quantum of at least four levels on the heavy oil-miscible phase fluid by the phase separator with light quantum of multi levels, such that a linear mass of each of the at least two fluid media is obtained.

The phase separator with light quantum of multi levels can carry out a measurement with light quantum of multi levels on the heavy oil-miscible phase fluid in the pipeline by emitting the light quantum of at least four levels, so as to obtain the linear mass of each of the at least two fluid media.

Specifically, the light quantum is abbreviated as photon, which is elementary particle for transmitting electromagnetic interaction and is a kind of gauge boson. Photon is a carrier of electromagnetic radiation, and in quantum field theory, photon is considered as the medium of electromagnetic interaction. Compared with most elementary particles, the static mass of photon is zero, which means that their propagation velocity in vacuum is the speed of light. Like other quantum, photon has wave-particle duality: photon can show the properties of refraction, interference and diffraction of classical waves; the particle nature of photon can be proved by photoelectric effect. Photon can only transfer quantized energy, which is a lattice particle and a mass energy phase of a loop quantum particle. The energy of a photon is proportional to the frequency of the light wave. The higher the frequency is, the higher the energy is. When a photon is absorbed by an atom, an electron gains enough energy to transition from the inner orbit to the outer orbit, and the atom with electronic transition changes from the ground state to the excited state_{◦}

A Ba-133 light quantum source is used in the phase separator with light quantum of multi levels, which emits the light quantum of multi levels taking four levels as an example, wherein energy of the light quantum of first level is 31 keV, the energy of the light quantum of second level is 81 keV, the energy of the light quantum of third level is 160 keV, the energy of the light quantum of fourth level is 356 keV. A known Ba-133 light quantum source has a radioactivity of 25 microcurie, can emit nearly one million single light quanta of the energy levels 31 keV, 81 keV, 160 keV and 356 keV. Through the measurement of energy of each light quantum, the measurement of phase fraction of the heavy oil-miscible phase fluid is completed according to the photoelectric cross section of the light quantum group of the energy of 31 keV, 81 keV and 160 keV and material, and Compton cross section of the light quantum group of energy of 356 keV and material.

104, obtaining a flux of each of the at least two fluid media from the total flux of throttling differential pressure and the linear mass of each of the at least two fluid media.

The linear mass of each of the at least two fluid media is divided by a linear mass sum of all the at least two fluid media, to obtain a mass fraction of each of the at least two fluid media; and then the mass fraction of each of the at least two fluid media is multiplied by the total flux of throttling differential pressure, to obtain the flux for each of the at least two fluid media.

The implementation principle of the present embodiment is as follows: Since the device for measuring a flux of a heavy oil-miscible phase fluid in a large diameter pipeline is installed on the pipeline, the heavy oil-miscible phase fluid flows out of the oil and gas well, the total flux of throttling differential pressure of the heavy oil-miscible phase fluid in the streamlined spindle is measured, and then a measurement with a light quantum of at least four levels is carried out on the heavy oil-miscible phase fluid by the phase separator with light quantum of multi levels, such that a linear mass of each of the at least two fluid media is obtained. A flux of each of the at least two fluid media is obtained from the total flux of throttling differential pressure and the linear mass of each of the at least two fluid media. The flux for each of the at least two fluid media can be measured without sampling and separation test on the heavy oil-miscible phase fluid, thus realizing online measurement.

In the embodiment shown in FIG. 1, step 102 of measuring a total flux of throttling differential pressure is conducted as follows:

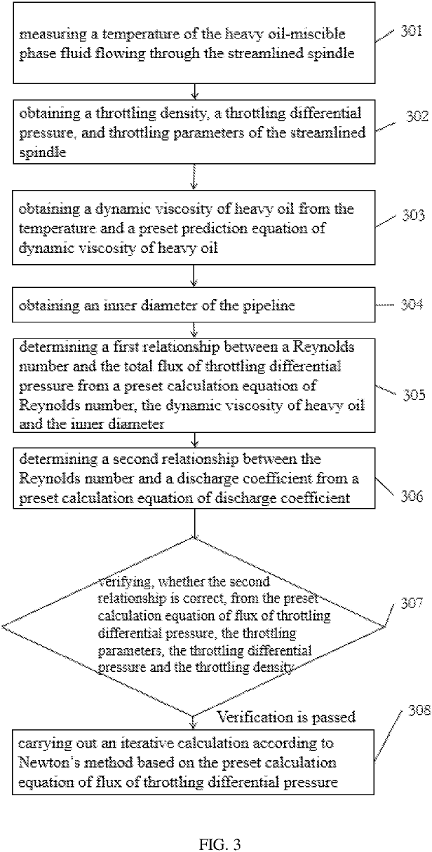

Referring to FIG. 3, a step of measuring a total flux of throttling differential pressure of the heavy oil-miscible phase fluid flowing through the streamlined spindle includes:

301, measuring a temperature of the heavy oil-miscible phase fluid flowing through the streamlined spindle.

Specially, a temperature sensor can be configured to carry out the measurement, to obtain the temperature t of the heavy oil-miscible phase fluid.

302, obtaining a throttling density, a throttling differential pressure, and throttling parameters of the streamlined spindle.

The throttling parameters of the streamlined spindle is determined by the production process, in particular, the throttling parameters include the equivalent throat diameter d, which is the equivalent diameter of the annular flow area of the throttling structure of the streamlined spindle; a diameter ratio β, which is the ratio of the equivalent throat diameter to the diameter of straight pipeline section; expansion coefficient ε; a throttling differential pressure ΔP, which is a differential pressure between a pressure tap of an upstream inlet and the equivalent throat diameter of the throttler of the streamlined spindle; throttling density ρ, which is a mixed density of the heavy oil-miscible phase fluid at the pressure tap of the equivalent throat diameter of the throttler.

303, obtaining a dynamic viscosity of heavy oil from the temperature and a preset prediction equation of dynamic viscosity of heavy oil.

The preset prediction equation of dynamic viscosity of heavy oil is:

$${\text{μ}}_{\text{t}} = \left(0.0148 ln \text{T} + 0.9421\right) ⋅ {\text{μ}}_{50} {}^{\left(3.1613 - 0.5525 ln \text{T}\right)}$$

where µ₅₀ is the dynamic viscosity of heavy oil at 50° C., T is centigrade, under standard atmospheric pressure, the freezing point of water is 0° C., and the boiling point of water is 100° C. The dynamic viscosity of heavy oil at the temperature of t is µₘᵢₓ, in mPa·s,

$${\text{μ}}_{\text{mix}} = {\text{μ}}_{\text{g}} ⋅ \text{GVF} \left|{\text{μ}}_{\text{w}} ⋅ \text{WVF}\right| {\text{μ}}_{\text{o}} ⋅ \text{OVF}$$

where GVF represents section gas content, WVF represents section water content, OVF represents section oil content, µ_{g} is dynamic viscosity of gas, µ_{w} is dynamic viscosity of water, µₒ is dynamic viscosity of oil. According to experience and common knowledge, the viscosity of three media gas, water and oil is adaptive obviously for µ_{g}<< µ_{w}<< µₒ. In fact, the dynamic viscosity of heavy oil µₘᵢₓ = µₒ·OVF.

304, obtaining an inner diameter of the pipeline.

The inner diameter of the pipeline D can be obtained by the pipeline manufacturer and the production label.

305, determining a first relationship between a Reynolds number and the total flux of throttling differential pressure from a preset calculation equation of Reynolds number, the dynamic viscosity of heavy oil and the inner diameter.

The preset calculation equation of Reynolds number is

$$Re = \frac{354}{\text{D} \cdot {\text{μ}}_{\text{mix}}} \text{Qm} ,$$

wherein the dynamic viscosity of heavy oil µₘᵢₓ is already calculated and the inner diameter D is obtained, then the first relationship between a Reynolds number Re and the total flux of throttling differential pressure Qm is determined.

306, determining a second relationship between the Reynolds number and a discharge coefficient from a preset calculation equation of discharge coefficient.

The preset calculation equation of discharge coefficient is C = bln Re + e, where the discharge coefficient C is a ratio of an actual flux to a theoretical flux of the heavy oil-miscible phase fluid, b is the first coefficient, e is the second coefficient. The value range of the Reynolds number is relative larger, while the coefficients b and e have different values based on different value ranges of the Reynolds number. Particularly,
if Re <= 2000, b = 0.0785, e = 0.2945;
if 2000 < Re <= 100000, b = 0.017, e = 0.7859;
if Re>100000, b=0, e = 0.995.
307, verifying, whether the second relationship is correct, from the preset calculation equation of flux of throttling differential pressure, the throttling parameters, the throttling differential pressure and the throttling density.

The preset calculation equation of flux of throttling differential pressure is

$$\text{Qm} = \text{C} ⋅ {\text{K}}_{1} \sqrt{\text{Δ} \text{P} \text{ρ}} ,$$

where the constant

$${\text{K}}_{1} = \frac{\sqrt{2} e ⋅ π {\text{d}}^{2}}{4 \sqrt{1 - {\text{β}}^{4}}} ,$$

the equivalent throat diameter d, the diameter ratio ß, the expansion coefficient ε, the throttling differential pressure ΔP, and the throttling density ρ are known, when verifying whether the second relationship is correct, only when the incidence relationship between the discharge coefficient C and the Reynolds number is verified to be correct, calculation of Qm would be correct.

Firstly, considering the case of Re>100000, where b=0, the discharge coefficient of heavy oil C=e=0.995, and then calculating Qm; then calculating the Reynolds number Re through

$$Re = \frac{354}{\text{D} \cdot {\text{μ}}_{\text{mix}}} \text{Qm;}$$

if the value is greater than 100000, then the current calculation is correct.

For the case of 2000 < Re ≤ 100000, if the calculated Re lies within this range, then the current calculation is correct, and then calculating the discharge coefficient of heavy oil C through C= 0.017In Re + 0.7859.

For the case of Re≤ 2000, if the calculated Re lies within this range, then the current calculation is correct, and then calculating the discharge coefficient of heavy oil C through C= 0.0785In Re + 0.2945.

After the above verification is passed, executing step 308. If it fails, there may be data errors and subsequent calculations will not be performed.

308, carrying out an iterative calculation according to Newton’s method based on the preset calculation equation of flux of throttling differential pressure.

After the verification in step 307 is passed, the step of carrying out an iterative calculation according to Newton’s method mainly includes:
transforming the preset calculation equation of flux of throttling differential pressure to
$$\text{Qm} = \frac{\text{n}}{\sqrt{1 - {\text{β}}^{4}}} \text{ε} \frac{π}{4} {\text{d}}^{2} \sqrt{2 \text{Δ} \text{P} \text{ρ}} , \text{where} \text{z} = \frac{4 \sqrt{1 - {\text{β}}^{4}}}{\text{ε} ⋅ π {\text{d}}^{2} \sqrt{2 \text{Δ} \text{P} \text{ρ}}} , \text{a} = \frac{354}{\text{D} ⋅ {\text{μ}}_{\text{mix}}} ,$$
Re= aQm are defined to simplify expression, such that the above equation is transformed to
$$\text{Qm} = \frac{1}{\text{z}} ⋅ \text{C} = \frac{1}{\text{z}} ⋅ \left(\text{b} ln Re + \text{e}\right) = \frac{1}{\text{z}} ⋅ \left(\text{b} ln \left(\text{a} \text{Qm}\right) + \text{e}\right) ;$$
thereby z · Qm = b · ln(a · Qm) + e is determined, wherein let
$$\text{f} \left(\text{Qm}\right) = \text{zQm} - \text{b} ln \left(\text{a} ⋅ \text{Qm}\right) - \text{e,} \text{then} {\text{f}}^{′} \left(\text{Qm}\right) = \text{z} - \frac{\text{b}}{\text{Qm}}$$
is obtained after derivation;
the value of Qm can be iteratively calculated according to Newton’s method:
if the discharge coefficient C=0.995, the calculated Qm is set to be Q₀,
$${\text{Qm}}_{\text{n} + 1} = {\text{Qm}}_{\text{n}} - \frac{{\text{zQm}}_{\text{n}} - \text{b} ln \left(\text{a} {\text{Qm}}_{\text{n}}\right) - \text{e}}{\text{z} - \frac{\text{b}}{{\text{Qm}}_{\text{n}}}} ;$$
introducing the calculated Q₀ into the above iteration equation, Q₁, Q₂,... are calculated. and then judging whether the next iteration should be conducted based on approaching degree of Qmₙ₊₁ and Qmₙ ( whether difference is smaller than 1% ). Particularly, if (QMₙ₊₁- Q.mₙ) / Qmₙ₊₁ is larger than 0.01, continuing to carry out iteration calculation; if ( Qmₙ₊₁ - Qmₙ ) / Qmₙ₊₁ is smaller than or equal to 0.01, ending the calculation, and obtaining the total flux of throttling differential pressure Qm.

The implementation principle of the present embodiment is as follows: for a throttler formed by a streamlined spindle, the dynamic viscosity of heavy oil can be derived from a temperature. The flux can be calculated through the relationship between the Reynolds number and the total flux of throttling differential pressure, the Reynolds number and discharge coefficient. After confirming that the relationship between the flux calculation and the Reynolds number has been verified, Newton’s method can be used for iterative calculation to ensure more accurate calculation of the total flux of throttling differential pressure.

In step 103 of the above embodiment shown in FIG. 1, it is Ba-133 light quantum source as the phase separator with light quantum of multi levels emits light quantum, taking four groups of light quantum as an example, wherein energy of the light quantum of first level is 31 keV, energy of the light quantum of second level is 81 keV, energy of the light quantum of third level is 160 keV, energy of the light quantum of fourth level is 356 keV. The linear mass of each fluid medium is concretely calculated as follows:

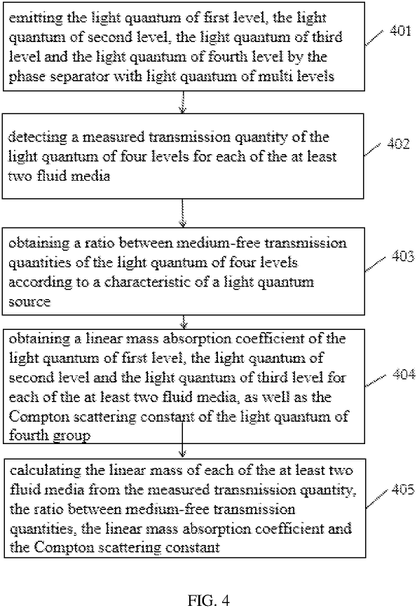

Referring to FIG. 4, a step of calculating the linear mass of each fluid medium includes:

401, emitting the light quantum of first level, the light quantum of second level, the light quantum of third level and the light quantum of fourth level by the phase separator with light quantum of multi levels.

402, detecting a measured transmission quantity of the light quantum of four levels for each of the at least two fluid media.

Wherein the measured transmission quantity of light quantum of four levels passing through the heavy oil-miscible phase fluid is detected by the light quantum probe.

403, obtaining a ratio between medium-free transmission quantities of the light quantum of four levels according to a characteristic of a light quantum source.

Wherein there is ratio between the inherent characteristic of Ba-133 light quantum source and the medium-free transmission quantities of the light quantum of different levels N₀,₁, N_{0,2}, N_{0,3}, N_{0,4}, N_{0,2} = f₂ N_{0,1}, N_{0,3} = f₃N_{0,1}, N_{0,4} = f₄ N_{0,1}, wherein f₂, f₃ and f₄ are known proportional coefficients, which are natural constant coefficients and do not change with any measurement conditions. Because of existence of the proportional coefficients, three unknown quantities N_{0,1}, N_{0,2}, N_{0,3} and N_{0,4} can actually be regarded as one unknown quantity N_{0,1}, thus eliminating the need for measurement or calibration of N_{0,1}. Since N_{0,1} is not required to be calibrated, influence of temperature drift in the light quantum probe on the measurement is fundamentally avoided, thereby it isn’t necessary to arrange a thermostat in the light quantum probe, which saves equipment costs while eliminating calibration of the medium-free transmission quantity.

404, obtaining a linear mass absorption coefficient of the light quantum of first level, the light quantum of second level and the light quantum of third level for each of the at least two fluid media, as well as the Compton scattering constant of the light quantum of fourth group.

Wherein the calculation principle of the calibration value of the linear mass absorption coefficient for each of the at least two fluid media is:
(1) emitting the light quantum of first level, the light quantum of second level, the light quantum of third level and the light quantum of fourth level, when the pipeline is filled with a single fluid medium;
(2) detecting the single-fluid-medium transmission quantity of the light quantum of first level N_{x,1}, the single-fluid-medium transmission quantity of the light quantum of second level N_{x,2}, the single-fluid-medium transmission quantity of the light quantum of third level N_{x,3}, and the single-fluid-medium transmission quantity of the light quantum of fourth level N_{x,4};
(3) calculating the single-fluid-medium linear mass absorption coefficient of the light quantum of first level α_{x,1} from the medium-free transmission quantity of the light quantum of first level N_{x,1} and the single-fluid-medium photoelectric absorption equation;

Assuming that the fluid media in the miscible phase fluid include gas, water and oil, the photoelectric absorption equation of the light quantum of first level is In

$$\left(\frac{{\text{N}}_{\text{o} , 1}}{{\text{N}}_{\text{x} , 1}}\right) = {\text{α}}_{\text{g,1}} {\text{Q}}_{\text{g}} + {\text{α}}_{\text{w,1}} {\text{Q}}_{\text{w}} + {\text{α}}_{\text{o,1}} {\text{Q}}_{\text{o}} ,$$

where subscript g represents gas phase, subscript w represents water phase, subscript o represents oil phase, α_{g,} ₁ is the linear mass absorption coefficient of gas, α_{w}, ₁ is the linear mass absorption coefficient of water, αₒ, ₁ is the linear mass absorption coefficient of oil, Q_{g} is linear mass of gas, Q_{w} is linear mass of water, Qₒ is linear mass of oil. When the single fluid medium is a gas phase, the single-fluid-medium photoelectric absorption equation becomes In

$$\left(\frac{{\text{N}}_{0 , 1}}{{\text{N}}_{\text{g} , 1}}\right) = {\text{α}}_{\text{g,1}} {\text{Q}}_{\text{g}} , \text{and} {\text{α}}_{\text{g} , 1} = \frac{ln \left(\frac{{\text{N}}_{0 , 1}}{{\text{N}}_{\text{g} , 1}}\right)}{{\text{Q}}_{\text{g}}}$$

is obtained after transformation. Similarly,

$${\text{α}}_{\text{w,1}} = \frac{ln \left(\frac{{\text{N}}_{\text{0,1}}}{{\text{N}}_{\text{w,1}}}\right)}{{\text{Q}}_{\text{w}}} \text{and} {\text{α}}_{\text{o} , 1} = \frac{ln \left(\frac{{\text{N}}_{0 , 1}}{{\text{N}}_{\text{o} , 1}}\right)}{{\text{Q}}_{\text{o}}}$$

can be obtained.

(4) calculating the single-fluid-medium linear mass absorption coefficient of the light quantum of second level α_{x,2} from the medium-free transmission quantity of the light quantum of second level N_{0,2} and the single-fluid-medium photoelectric absorption equation of the light quantum of second level; similar to (3).

(5) calculating the single-fluid-medium linear mass absorption coefficient of the light quantum of third level α_{x,3} from the medium-free transmission quantity of the light quantum of third level N_{0,3} and the single-fluid-medium photoelectric absorption equation of the light quantum of third level; similar to (3).

(6) Obtaining a Compton scattering constant K from a Compton scattering characteristic of the light quantum of fourth level.

Since the Compton scattering is independent on scattering material, so for the light quantum of fourth level with energy of 356 keV, the Compton scattering property is the Compton scattering constant K₂, and the Compton absorption equation of the miscible phase fluid of the light quantum of the fourth level (with energy of 356 keV) for each of the at least two fluid media is:

$$ln \left(\frac{{N}_{\text{o} , 4}}{{N}_{\text{x,4}}}\right) = {\text{K}}_{2} ∗ \left({\text{Q}}_{\text{g}} + {\text{Q}}_{\text{w}} + {\text{Q}}_{\text{o}}\right)$$

405, calculating the linear mass of each of the at least two fluid media from the measured transmission quantity, the ratio between medium-free transmission quantities, the linear mass absorption coefficient and the Compton scattering constant.

Wherein the photoelectric absorption total equation of the light quantum of first level for each of the at least two fluid media is In

$$\left(\frac{{\text{N}}_{0 , 1}}{{\text{N}}_{\text{Z} , 1}}\right) = {\text{α}}_{\text{g,1}} {\text{Q}}_{\text{g}} + {\text{α}}_{\text{w,1}} {\text{Q}}_{\text{w}} + {\text{α}}_{\text{o,1}} {\text{Q}}_{\text{o}} ,$$

the photoelectric absorption total equation of the light quantum of second level for each of the at least two fluid media is In

$$\left(\frac{{\text{N}}_{\text{o} , 2}}{{\text{N}}_{\text{X} , 2}}\right) = {\text{α}}_{\text{g,2}} {\text{Q}}_{\text{g}} + {\text{α}}_{\text{w,2}} {\text{Q}}_{\text{w}} + {\text{α}}_{\text{o,2}} {\text{Q}}_{\text{o}} ,$$

the photoelectric absorption total equation of the light quantum of third level for each of the at least two fluid media is In

$$\left(\frac{{\text{N}}_{0 , 3}}{{\text{N}}_{\text{x} , 3}}\right) = {\text{α}}_{\text{g,3}} {\text{Q}}_{\text{g}} + {\text{α}}_{\text{w,3}} {\text{Q}}_{\text{w}} + {\text{α}}_{\text{o,3}} {\text{Q}}_{\text{o}} ,$$

the Compton absorption equation of the light quantum of fourth level for each of the at least two fluid media is

$$ln \left(\frac{{N}_{\text{o} , 4}}{{N}_{\text{x,4}}}\right) = {\text{K}}_{2} ∗ \left({\text{Q}}_{\text{g}} + {\text{Q}}_{\text{w}} + {\text{Q}}_{\text{o}}\right) .$$

$$\text{because} {\text{N}}_{0 , 2} = {\text{f}}_{2} {\text{N}}_{0 , 1} , {\text{N}}_{0 , 3} = {\text{f}}_{3} {\text{N}}_{0 , 1} , {\text{N}}_{0 , 4} = {\text{f}}_{4} {\text{N}}_{0 , 1} ,$$

$$\text{then} ln \left(\frac{{\text{N}}_{0 , 1}}{{\text{N}}_{\text{x} , 2}}\right) = {\text{α}}_{\text{g} , 2} {\text{Q}}_{\text{g}} + {\text{α}}_{\text{w} , 2} {\text{Q}}_{\text{w}} + {\text{α}}_{\text{o} , 2} {\text{Q}}_{\text{o}} = ln \left(\frac{{\text{f}}_{2} {\text{N}}_{0 , 1}}{{\text{N}}_{\text{x} , 2}}\right)$$

$$ln \left(\frac{{\text{N}}_{0 , 3}}{{\text{N}}_{\text{x} , 3}}\right) = {\text{α}}_{\text{g} , 3} {\text{Q}}_{\text{g}} + {\text{α}}_{\text{w} , 3} {\text{Q}}_{\text{w}} + {\text{α}}_{\text{o} , 3} {\text{Q}}_{\text{o}} = ln \left(\frac{{\text{f}}_{3} {\text{N}}_{0 , 1}}{{\text{N}}_{\text{x} , 3}}\right)$$

$$ln \left(\frac{{N}_{\text{o} , 4}}{{\text{N}}_{\text{X,4}}}\right) = {\text{K}}_{2} ∗ \left({\text{Q}}_{\text{g}} + {\text{Q}}_{\text{w}} + {\text{Q}}_{\text{o}}\right) = ln \left(\frac{{\text{f}}_{4} {\text{N}}_{\text{o} , 1}}{{\text{N}}_{\text{X} , 4}}\right)$$

N_{0,1}, Q_{g}, Q_{w}, Qₒ can be calculated.

The implementation principle of the present embodiment is: measuring the linear mass of the fluid media in the miscible phase fluid by taking the miscible phase fluid including gas, water and oil as an example. In the calculation process, the required linear mass absorption coefficient and Compton scattering constant are calibration values, which can be calibrated and calculated respectively through the pipeline state of full water, full gas and full oil. The ratio between the measured transmission quantity and the medium-free transmission quantity can be introduced into the photoelectric absorption equation and Compton absorption equation of the light quantum of four different levels, which can realize linear mass of gas, linear mass of water and linear mass of oil of the miscible phase fluid.

In the above embodiment shown in FIG. 4, after calculating Q_{g}, Q_{w} and Qₒ, a flux of each of the at least two fluid media can be obtained from the total flux of throttling differential pressure and the linear mass of each of the at least two fluid media, which includes:
dividing the linear mass of each of the at least two fluid media by a linear mass sum of all the at least two fluid media, to obtain a mass fraction of each of the at least two fluid media, the calculation is so conducted:
the mass fraction of gas phase:
$$\text{GMF} = \frac{{\text{Q}}_{\text{g}}}{{\text{Q}}_{\text{g}} + {\text{Q}}_{\text{w}} + {\text{Q}}_{\text{o}}} ;$$
the mass fraction of water phase:
$$\text{WMF} = \frac{{\text{Q}}_{\text{w}}}{{\text{Q}}_{\text{g}} + {\text{Q}}_{\text{w}} + {\text{Q}}_{\text{o}}} ;$$
the mass fraction of oil phase:
$$\text{OMF} = \frac{{\text{Q}}_{\text{o}}}{{\text{Q}}_{\text{g}} + {\text{Q}}_{\text{w}} + {\text{Q}}_{\text{o}}} .$$
multiplying the mass fraction of each of the at least two fluid media by the total flux of throttling differential pressure, to obtain the flux for each of the at least two fluid media, the calculation is so conducted:
   the flux for oil phase: Q′ₒ = OMF · Qm;
   the flux for gas phase: Q′_{g} = GMF · Qm;
   the flux for water phase: Q′_{w} = WMF · Qm.

As shown in FIG. 2, A device for measuring a flux of a heavy oil-miscible phase fluid in a large diameter pipeline is disclosed, including:
a streamlined spindle 202 and a phase separator with light quantum of multi levels 203, wherein a heavy oil-miscible phase fluid flows out of an oil and gas well through the pipeline 201;
wherein the device is configured to carry out the method for measuring a flux of a heavy oil-miscible phase fluid in a large diameter pipeline of the above embodiments, to obtain the flux for each of the at least two fluid media in the heavy oil-miscible phase fluid.

The above are preferred embodiments of the present disclosure, and the protection scope of the present disclosure is not limited accordingly. Unless otherwise specified, any features disclosed in the present specification (including the abstract and drawings) can be replaced by other equivalent or similar alternative features. That is, unless otherwise stated, each feature is only one example of a series of equivalent or similar features.

What is claimed is:

1. A method for measuring a flux of a heavy oil-miscible phase fluid, wherein the method is applicable to a device for measuring the flux of the heavy oil-miscible phase fluid installed on a pipeline and comprising a streamlined spindle and a multi-level light quantum-based phase separator, and the method comprises:
flowing of the heavy oil-miscible phase fluid out of an oil and gas well through the pipeline, with the heavy oil-miscible phase fluid comprising at least two fluid media;
measuring a total flux of the heavy oil-miscible phase fluid flowing through the streamlined spindle;
carrying out a measurement with a light quantum of at least four levels on the heavy oil-miscible phase fluid by using the multi-level light quantum-based phase separator to obtain a linear mass of each of the at least two fluid media; and
obtaining a flux for each of the at least two fluid media from the total flux and the linear mass of each of the at least two fluid media.

2. The method for measuring a flux of a heavy oil-miscible phase fluid according to claim 1, wherein the step of measuring a total flux of the heavy oil-miscible phase fluid flowing through the streamlined spindle comprises:
measuring a temperature of the heavy oil-miscible phase fluid flowing through the streamlined spindle;
obtaining a throttling density, a throttling differential pressure, and throttling parameters of the streamlined spindle, wherein the throttling differential pressure is a differential pressure between a pressure tap at an upstream inlet and a pressure tap at a throttling structure with an equivalent throat diameter of a throttler of the streamlined spindle, and the throttling density being a mixed density of the heavy oil-miscible phase fluid at the pressure tap at the throttling structure with the equivalent throat diameter of the throttler; and
calculating the total flux from the temperature, the throttling parameters, the throttling density and a preset flux calculation equation.

3. The method for measuring a flux of a heavy oil-miscible phase fluid according to claim 2, wherein the step of calculating the total flux from the temperature, the throttling parameters, the throttling density and a preset flux calculation equation comprises:
obtaining a dynamic viscosity of heavy oil in the heavy oil-miscible phase fluid from the temperature and a preset dynamic viscosity prediction equation of the heavy oil;
obtaining an inner diameter of the pipeline;
determining a first relationship between a Reynolds number and the total flux from a preset Reynolds number calculation equation, the dynamic viscosity of the heavy oil and the inner diameter;
determining a second relationship between the Reynolds number and a discharge coefficient from a preset discharge coefficient calculation equation, wherein the discharge coefficient is a ratio of an actual flux to a theoretical flux of the heavy oil-miscible phase fluid;
verifying, whether the second relationship is correct, from the preset flux calculation equation, the throttling parameters, the throttling differential pressure and the throttling density; and
carrying out an iterative calculation according to Newton’s method based on the preset flux calculation equation, when the second relationship is correct.

4. The method for measuring a flux of a heavy oil-miscible phase fluid according to claim 1, wherein
the multi-level light quantum-based phase separator with light quantum of multi levels is a four-level light quantum-based phase separator, and
the step of carrying out a measurement with a light quantum of at least four levels on the heavy oil-miscible phase fluid by using the multi-level light quantum-based phase separator to obtain a linear mass of each of the at least two fluid media comprises:
emitting a light quantum of first level, a light quantum of second level, a light quantum of third level and a light quantum of fourth level from the multi-level light quantum-based phase separator, with energy of the light quantum of first level being 31 keV, energy of the light quantum of second level being 81 keV, energy of the light quantum of third level being 160 keV, and energy of the light quantum of fourth level being 356 keV;
detecting a measured transmission quantity of the light quantum of four levels for each of the at least two fluid media;
obtaining a ratio between medium-free transmission quantities of the light quantum of four levels, wherein the medium-free transmission quantity is a transmission quantity in an empty and medium-free pipeline;
obtaining a linear mass absorption coefficient of the light quantum of first level, the light quantum of second level and the light quantum of third level for each of the at least two fluid media, and Compton scattering constant of the light quantum of fourth level; and
calculating the linear mass of each of the at least two fluid media from the measured transmission quantity, the ratio between medium-free transmission quantities, the linear mass absorption coefficient and the Compton scattering constant.

5. The method for measuring a flux of a heavy oil-miscible phase fluid according to claim 4, wherein the step of obtaining a ratio between medium-free transmission quantities of the light quantum of four levels comprises:
defining the medium-free transmission quantity of the light quantum of first level as N_{0,1}, a ratio of the medium-free transmission quantity of the light quantum of second level N_{0,2} to N_{0,1} as f₂, a ratio of the medium-free transmission quantity of the light quantum of third level N_{0,3} to N_{0,1}as f₃, and a ratio of the medium-free transmission quantity of the light quantum of fourth level N_{0,4} to N_{0,1}as f₄ according to a characteristic of a light quantum source.

6. The method for measuring a flux of a heavy oil-miscible phase fluid according to claim 5, wherein the step of calculating the linear mass of each of the at least two fluid media from the measured transmission quantity, the ratio between medium-free transmission quantities, the linear mass absorption coefficient and the Compton scattering constant comprises:
controlling the multi-level light quantum-based phase separator to emit the light quantum of first level, the light quantum of second level, the light quantum of third level and the light quantum of fourth level in a second pipeline filled with a single fluid medium;
detecting a single-fluid-medium transmission quantity of the light quantum of first level N_{x,1}, a single-fluid-medium transmission quantity of the light quantum of second level N_{x,2}, a single-fluid-medium transmission quantity of the light quantum of third level N_{x,3}, and a single-fluid-medium transmission quantity of the light quantum of fourth level N_{x,4};
calculating a single-fluid-medium linear mass absorption coefficient of the light quantum of first level α_{x,1} from the medium-free transmission quantity of the light quantum of first level N_{0,1} and a single-fluid-medium photoelectric absorption equation of the light quantum of first level;
calculating a single-fluid-medium linear mass absorption coefficient of the light quantum of second level α_{x,2} from the medium-free transmission quantity of the light quantum of second level N_{0,2} and a single-fluid-medium photoelectric absorption equation of the light quantum of second level;
calculating a single-fluid-medium linear mass absorption coefficient of the light quantum of third level α_{x,3} from the medium-free transmission quantity of the light quantum of third level N_{0,3} and a single-fluid-medium photoelectric absorption equation of the light quantum of third level; and
obtaining the Compton scattering constant K₂ from a Compton scattering characteristic of the light quantum of fourth level.

7. The method for measuring a flux of a heavy oil-miscible phase fluid according to claim 6, wherein the step of calculating a single-fluid-medium linear mass absorption coefficient of the light quantum of first level α_{x,1} from the medium-free transmission quantity of the light quantum of first level N_{0,1}and a single-fluid-medium photoelectric absorption equation of the light quantum of first level comprises:
transforming a photoelectric absorption total equation of the light quantum of first level for each of the at least two fluid media into a single-fluid-medium photoelectric absorption equation
$$ln \left(\frac{{\text{N}}_{\text{o} , 1}}{{\text{N}}_{\text{X} , 1}}\right) = {\text{α}}_{\text{x} , 1} {\text{Q}}_{\text{x}} ; \text{and}$$
introducing the medium-free transmission quantity of the light quantum of first level N_{0,1} and the single-fluid-medium transmission quantity of the light quantum of first level N_{x,1} into the photoelectric absorption total equation of the light quantum of first level for each of the at least two fluid media, to obtain the single-fluid-medium linear mass absorption coefficient of the light quantum of first level
$${\text{α}}_{\text{x} , 1} = \frac{ln \left(\frac{{\text{N}}_{0 , 1}}{{\text{N}}_{\text{x} , 1}}\right)}{{\text{Q}}_{\text{x}}}$$
.

8. The method for measuring a flux of a heavy oil-miscible phase fluid according to claim 7, wherein the step of calculating the linear mass of each of the at least two fluid media from the measured transmission quantity, the ratio between medium-free transmission quantities, the linear mass absorption coefficient and the Compton scattering constant comprises:
introducing the measured transmission quantity, the ratio between medium-free transmission quantities, the linear mass absorption coefficient and the Compton scattering constant into the photoelectric absorption total equation of the light quantum of first level for each of the at least two fluid media, a photoelectric absorption total equation of the light quantum of second level for each of the at least two fluid media, a photoelectric absorption total equation of the light quantum of third level for each of the at least two fluid media and a Compton absorption equation of the light quantum of fourth level, respectively, to calculate the linear mass of each of the at least two fluid media Qₓ.

9. The method for measuring a flux of a heavy oil-miscible phase fluid according to claim 1, wherein the step of obtaining a flux for each of the at least two fluid media from the total flux and the linear mass of each of the at least two fluid media comprises:
dividing the linear mass of each of the at least two fluid media by a linear mass sum of all the at least two fluid media, to obtain a mass fraction of each of the at least two fluid media; and
multiplying the mass fraction of each of the at least two fluid media by the total flux, to obtain the flux for each of the at least two fluid media.

10. A device for measuring a flux of a heavy oil-miscible phase fluid, wherein the device is installed on the pipeline, the device comprising:
the streamlined spindle and the multi-level light quantum-based phase separator, wherein the heavy oil-miscible phase fluid flows out of the oil and gas well through the pipeline;
wherein the device is configured to carry out the method for measuring a flux of a heavy oil-miscible phase fluid according to claim 1, to obtain the flux for each of the at least two fluid media in the heavy oil-miscible phase fluid.
